(19) United States
(12) Patent Application Publication
(10) Pub. No.: US 2026/0237215 A1
(43) Pub. Date: Aug. 13, 2026

(54) COCKPIT MONITORING SYSTEM AND METHOD THEREOF

(71) Applicant: HON HAI PRECISION INDUSTRY CO., LTD., New Taipei City (TW)

(72) Inventors: Chin Hui LIN, New Taipei City (TW); Hao Syuan CHANG, New Taipei City (TW)

(21) Appl. No.: 19/218,574

(22) Filed: May 26, 2025

(30) Foreign Application Priority Data
Feb. 7, 2025 (TW) 114104686

(51) Int. Cl. G06V 20/52; G06F 16/3329; G06F 40/30; G06F 40/40; G06V 20/59

(52) U.S. Cl. CPC G06V 20/52; G06F 16/33295; G06F 40/30; G06F 40/40; G06V 20/593

(57) ABSTRACT

A cockpit monitoring system includes: a camera, a first computing circuit, a database, an input device and a second computing circuit. The camera films a cockpit. The first computing circuit is configured to: analyze an image received from the camera by using an image analysis large language model, to generate a recorded text. The database stores the recorded text. The input device is configured to generate a question text. The second computing circuit is configured to: perform a semantic analysis to the question text by a speech-assisted large language model; and query the recorded text in the database according to semantic analysis results of the question text, to generate an answer text.

### CROSS-REFERENCE TO RELATED APPLICATION

This application claims priority to Taiwan Application Serial Number 114104686, filed Feb. 7, 2025, which is herein incorporated by reference in its entirety.

### BACKGROUND

### Field of Invention

This disclosure relates to a cockpit monitoring system and method, and in particular to the cockpit monitoring system equipped with a large language model and method.

### Description of Related Art

While driving, if a driver wants to check the condition in the vehicle's cockpit, he or she may not be able to concentrate on the road condition, and it may increase the probability of an accident. An image identification system is usually installed inside a vehicle to film and store image data inside the cockpit, so as to assist the driver in monitoring the condition inside the cockpit by image analysis technology. However, storing high-quality image data requires a large amount of storage space, and using image analysis technology to perform operations on images consumes a large amount of computing power.

How to save the storage space required for performing image analysis and improve the computing efficiency of the system when monitoring the condition in the cockpit is an important issue that technicians in this field need to deal with.

### SUMMARY

The present disclosure provides a cockpit monitoring system. The cockpit monitoring system comprises: a camera, a first computing circuit, a database, an input device and a second computing circuit. The camera is configured to film a cockpit. The first computing circuit is coupled to the camera, configured to: analyze an image received from the camera by an image analysis large language model to generate a recorded text. The database is coupled to the first computing circuit and configured to store the recorded text. The input device is configured to generate a question text. The second computing circuit is coupled to the database and the input device, configured to: perform a semantic analysis to the question text by a speech-assisted large language model; and query the recorded text in the database according to a semantic analysis result of the question text to generate an answer text.

The present disclosure provides a cockpit monitoring method. The cockpit monitoring method comprises: filming a cockpit by a camera; analyzing an image received from the camera by an image analysis large language model to generate a recorded text; storing the recorded text into a database; generating a question text; performing a semantic analysis to the question text by a speech-assisted large language model; and querying the recorded text in the database according to a semantic analysis result of the question text to generate an answer text.

According to the embodiments of the present disclosure, since the cockpit monitoring system stores text data instead of image images, the large amount of storage space can be saved. Furthermore, the cockpit monitoring system analyzes and applies the text stored in the database, thereby can improve computing efficiency of the system when querying data.

### BRIEF DESCRIPTION OF THE DRAWINGS

FIG. 1 is a schematic diagram of a cockpit monitoring system according to an embodiment of the present disclosure.

FIG. 2 is a schematic diagram of a cockpit and a recorded text according to an embodiment of FIG. 1.

FIG. 3 is a schematic diagram of question texts corresponding to answer texts according to of FIG. 1.

FIG. 4 is a flow chart of a cockpit monitoring method according to an embodiment of FIG. 1.

FIG. 5 is a flow chart of a database management method according to an embodiment of the present disclosure.

### DETAILED DESCRIPTION

The embodiments are described in detail below with reference to the appended drawings to better understand the aspects of the present disclosure. However, the provided embodiments are not intended to limit the scope of the disclosure, and the description of the structural operation is not intended to limit the order in which they are performed. Any device that has been recombined by components and produces an equivalent function is within the scope covered by the disclosure.

The terms used in the entire specification and the scope of the patent application, unless otherwise specified, generally have the ordinary meaning of each term used in the field, the content disclosed herein, and the particular content.

The terms “coupled” or “connected” as used herein may mean that two or more elements are directly in physical or electrical contact, or are indirectly in physical or electrical contact with each other. It can also mean that two or more elements interact with each other.

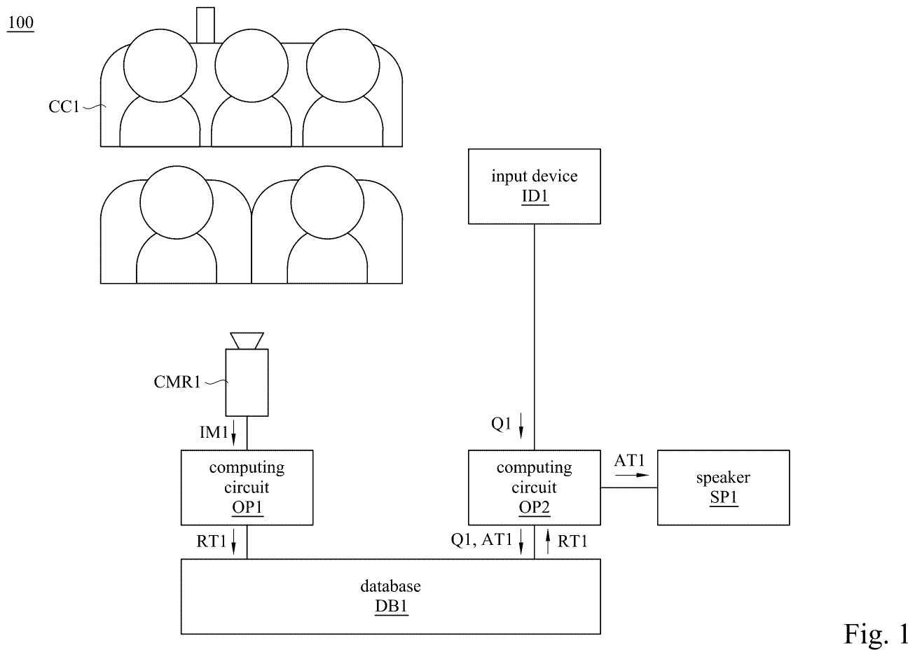

Reference is made to FIG. 1. FIG. 1 is a schematic diagram of a cockpit monitoring system 100 according to an embodiment of the present disclosure. In the embodiment of FIG. 1, the cockpit monitoring system 100 includes a camera CMR1, a computing circuit OP1, a database DB1, an input device ID1, a computing circuit OP2, and a speaker SP1.

The camera CMR1 is configured to take photos or film continuous images of the cockpit CC1. The cockpit CC1 may be an interior space of a vehicle, which may include a driver's seat, a front passenger seat and a rear seat space, and may also include a rear trunk. The camera CMR1 may be set at any position in the vehicle, including in front of a driver's seat, on the side of a rearview mirror, on the platform above an audio player, etc., to film the driver, all passengers and objects placed in various places in the cockpit CC1. In some embodiments, the cockpit monitoring system 100 may include multiple cameras, and the cameras may be disposed at different locations in the vehicle to film the cockpit CC1 from multiple angles.

The computing circuit OP1 is coupled to the camera CMR1. The computing circuit OP1 receives the image IM1 filmed by the camera CMR1. The image IM1 may be a continuous image of several seconds in length or a frame of a continuous image. The computing circuit OP1 is equipped with an image analysis large language model. The image analysis large language model may be configured to perform an image analysis to pictures or continuous images, and the image analysis large language model may convert the image content in the pictures or continuous images into text descriptions. The computing circuit OP1 may analyze an image IM1 by the image analysis large language model and convert the image IM1 (i.e., the condition in the cockpit CC1) as a recorded text RT1.

The database DB1 may receive and store the recorded text RT1 from the computing circuit OP1. It is worth to mention that the database DB1 of this disclosure is only configured to store text data such as the recorded text RT1 that describe the content of the image IM1, and not store the image IM1 itself.

The input device ID1 is configured to generate a question text Q1. Specifically, any passenger (such as the driver) in the cockpit CC1 is able to input questions by the input device ID1, so that the input device ID1 may generate the question text Q1. The input device ID1 allows the passenger to input desired questions by voice input, typing input, handwriting input or any text input technology (i.e., the input device ID1 may have at least one of a microphone, a handwriting pad or a typing keyboard to perform the above text input function). The input device ID1 is able to transmit the question text Q1 generated by it to the computing circuit OP2.

The computing circuit OP2 is coupled to the database DB1 and the input device ID1. The computing circuit OP2 may receive the recorded text RT1 from the database DB1, and receive the question text Q1 from the input device ID1. The computing circuit OP2 is equipped with a speech-assisted large language model. The computing circuit OP2 may perform a semantic analysis to the question text Q1 by the speech-assisted large language model, and query recorded texts stored in the database DB1 according to a semantic analysis result of the question text Q1. The recorded texts include the recorded text RT1. Next, the computing circuit OP2 may generate an answer text AT1 according to the text data stored in the database DB1, such as the recorded text RT1.

After the answer text AT1 is generated, the computing circuit OP2 may transmit the question text Q1 and the answer text AT1 together into the database DB1, so that the question text Q1 and the answer text AT1 are stored in the database DB1.

The computing circuit OP2 can also read out the text content of the answer text AT1 by the speaker SP1 in the cockpit CC1, thereby achieving the effect of conducting real-time questions and answers to the passenger who asks the above questions. Furthermore, the computing circuit OP2 may also offer operation suggestions to the passenger in the cockpit CC1 according to the answer text AT1. For example, the text content of the operation suggestion can be read out by the speaker SP1.

The speech-assisted large language model of the computing circuit OP2 may also directly analyze the recorded text RT1. When a specific word appears in the recorded text RT1, the computing circuit OP2 may control the speaker SP1 to send out an audio signal. For example, when the recorded text RT1 contains a sentence like “a passenger is not wearing a seat belt”, the speaker SP1 may send out an alarm.

In the cockpit monitoring system 100, the computing circuit OP1 may convert the image IM1 into the recorded text RT1 by the image analysis large language model, and stores the recorded text RT1 into the database DB1. The database DB1 only needs to store the recorded text RT1 and does not need to store the image IM1. In addition, the computing circuit OP2 queries the text content in the recorded text RT1 to analyze the condition of the cockpit CC1, instead of querying image data to obtain the result. In summary, since the cockpit monitoring system 100 stores text data instead of image images, a large amount of storage space can be saved. Furthermore, the cockpit monitoring system 100 analyzes and applies text data, thereby can improve computing efficiency of the system when querying data.

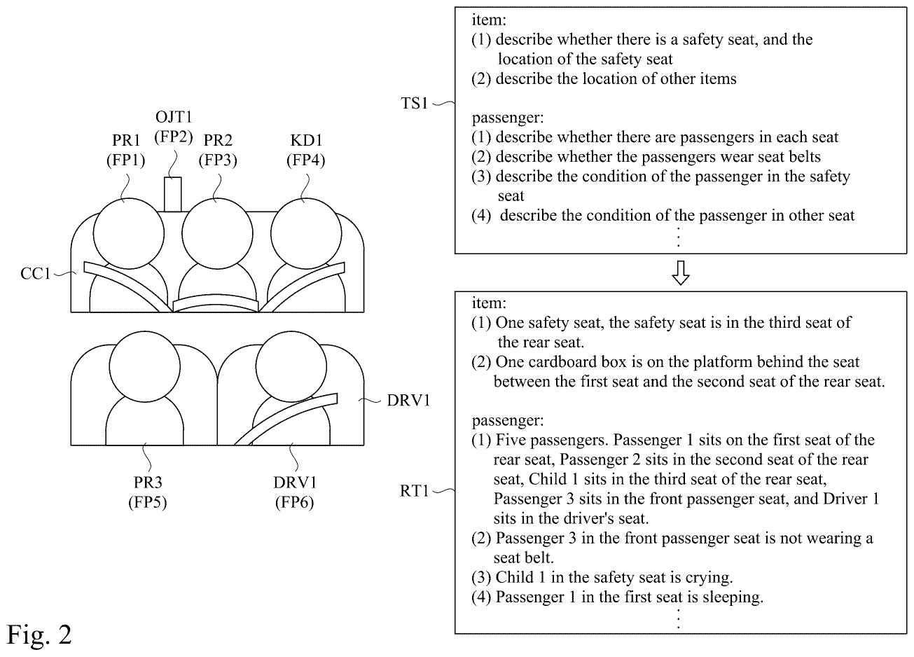

Refer to FIGS. 1 and 2. FIG. 2 is a schematic diagram of the cockpit CC1 and the recorded text RT1 according to an embodiment of FIG. 1. In an embodiment, the cockpit CC1 includes a driver DRV1, passengers PR1, PR2, PR3, a child KD1, and an object OJT1.

A variety of different text structures can be preset in the computing circuit OP1. For example, the text structure TS1 in FIG. 2. When the computing circuit OP1 analyzes the image IM1 by the image analysis large language model, the computing circuit OP1 can enable the image analysis large language model to apply the text structure TS1, thereby setting the recorded text RT1 to generate by the image analysis large language model conform to the text structure TS1.

In addition to the text structure, the computing circuit OP1 may also utilize the image analysis large language model to identify specific images from the image IM1, and record the condition of the specific images in the image IM1 as the form of text into the recorded text RT1.

Taking the embodiment of FIG. 2 as an example, the text structure TS1 shows that the text generated by the image analysis large language model must contain at least two paragraphs, “item” and “passenger”. In the paragraph “item”, the text needs to describe whether there is a safety seat in the cockpit CC1 and the location of each item; in the paragraph “passenger”, the text needs to describe whether there are passengers in each seat in the cockpit CC1, and describe the position relationship between each seat and each passenger, as well as the condition of each passenger.

In this embodiment, the computing circuit OP1 can identify the images of the passengers and the objects from the image IM1, and configure the passengers and the objects as the specific images. For example, the computing circuit OP1 may identify a first specific image FP1, a second specific image FP2, a third specific image FP3, a fourth specific image FP4, a fifth specific image FP5, a sixth specific image FP6, and a seventh specific image (not shown in FIG. 2) from the image IM1. The first specific image FP1 may correspond to the passenger PR1; the second specific image FP2 may correspond to the object OJT1; the third specific image FP3 may correspond to the passenger PR2; the fourth specific image FP4 may correspond to the child KD1; the fifth specific image FP5 may correspond to the passenger PR3; the sixth specific image FP6 may correspond to the driver DRV1; and the seventh specific image may correspond to a safety seat (the safety seat is also not shown in FIG. 2).

After the computing circuit OP1 analyzes the image IM1 utilizing the image analysis large language model, the computing circuit OP1 can correspond to the text structure TS1 to record the two paragraphs “item” and “passenger” in the recorded text RT1. The paragraph “item” in the record text RT1 is: “(1) One safety seat (not shown in FIG. 2), the safety seat is in the third seat of the rear seat. (2) One cardboard box (i.e., the item OJT1 in FIG. 2) is on the platform behind the seat between the first seat and the second seat of the rear seat.” The paragraph “passenger” in the record text RT1 is: “(1) Five passengers. Passenger 1 (i.e., the passenger PR1 in the FIG. 2) sits on the first seat of the rear seat, Passenger 2 (i.e., the passenger PR2 in FIG. 2) sits in the second seat of the rear seat, Child 1 (i.e., the child KD1 in FIG. 2) sits in the third seat of the rear seat, Passenger 3 (i.e., the passenger PR3 in FIG. 2) sits in the front passenger seat, and Driver 1 (i.e., driver DRV1 in FIG. 2) sits in the driver's seat. (2) Passenger 3 in the front passenger seat is not wearing a seat belt. (3) Child 1 in the safety seat is crying (the expression of the child KD1 is not shown in FIG. 2). (4) Passenger 1 in the first seat is sleeping (the facial state of the passenger PR1 is not shown in FIG. 2).”

It should be noted that the specific images, the text structure TS1 and the recorded text RT1 shown in the embodiment of FIG. 2 are only examples for letting people having ordinary skills in this art to easily understand the technical content of this disclosure. The number of the specific images is not limited to seven, and the images marked as the specific images are not limited to passengers, cartons, or safety seats. The content of the text structure TS1 is not limited to the content shown in FIG. 2. The text structure set by the computing circuit OP1 is not limited to the text structure TS1. There is no limit on the length of the text or the amount of information in the text in the recorded text RT1.

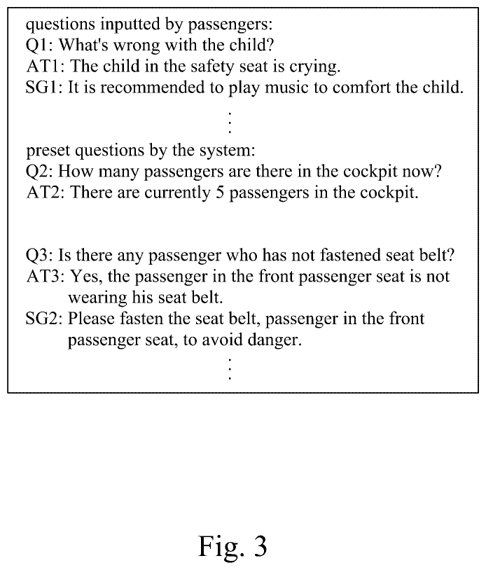

Reference is made to FIGS. 1, 2 and 3. FIG. 3 is a schematic diagram of question texts Q1-Q3 corresponding to answer texts ATI-AT3 according to of FIG. 1. In FIG. 3, when any passenger (e.g., the driver) in the cockpit CC1 inputs the question text Q1, the computing circuit OP2 of the cockpit monitoring system 100 may perform the semantic analysis to the question text Q1 by the speech-assisted large language model, and queries the recorded text RT1 according to the semantic analysis result of the question text Q1, to generate the answer text AT1. Furthermore, the speech-assisted large language model can generate an operation suggestion SG1 according to the answer text AT1, and offer the operation suggestion SG1 to the passengers in the cockpit CC1.

In this embodiment, the question text Q1 may be: “What's wrong with the child?” After the speech-assisted large language model performs the semantic analysis to the question text Q1, a semantic analysis result of the question text Q1 may be, allowing the speech-assisted large language model to query the text content about the status of “Child 1” in the recorded text RT1. Then, the speech-assisted large language model can generate the answer text AT1 according to the text content it queries in the recorded text RT1.

In this embodiment, the answer text AT1 may be: “The child in the safety seat is crying.” The operation suggestion SG1 may be: “It is recommended to play music to comfort the child.” The operation suggestion SG1 may be displayed on a vehicle display panel (not shown) of the cockpit CC1, or read out by the speaker SP1.

In some embodiments, in addition to receiving the question text inputted by the passenger, the computing circuit OP2 of the cockpit monitoring system 100 may also set preset question texts (e.g., the question texts Q2 and Q3 in FIG. 3). The speech-assisted large language model can perform the semantic analysis to the system preset question texts Q2 and Q3 respectively, and query the recorded text RT1 according to semantic analysis results of question texts Q2 and Q3 to generate the answer texts AT2 and AT3 respectively. The speech-assisted large language model can offer the operation suggestion SG2 according to the answer text AT3.

The question text Q2 may be: “How many passengers are there in the cockpit now?” After the speech-assisted large language model performs the semantic analysis to the question text Q2, a semantic analysis result of the question text Q2 may be, allowing the speech-assisted large language model to query the text content about the number of passengers in the recorded text RT1. Next, the speech-assisted large language model may generate the answer text AT2 according to the text content it retrieved in recorded text RT1. The answer text AT2 may be: “There are currently 5 passengers in the cockpit.”

The question text Q3 may be: “Is there any passenger who has not fastened seat belt?” Corresponding to the content of the recorded text RT1 in FIG. 2, the answer text AT3 may be: “Yes, the passenger in the front passenger seat is not wearing his seat belt.” The operation suggestion SG2 may be: “Please fasten the seat belt, passenger in the front passenger seat, to avoid danger.” The operation suggestion SG2 may be displayed on the vehicle display panel in the cockpit CC1, or read out by the speaker SP1.

In the embodiments above, the operation suggestion SG1 can be a part of the answer text AT1; and the operation suggestion SG2 can be a part of the answer text AT3. The computing circuit OP2 can store the question texts Q1-Q3 and the answer texts AT1~AT3 in FIG. 3 as text data into the database DB1. In addition, the computing circuit OP2 may configure the question text Q1 and the answer text AT1 as a first text data, the question text Q2 and the answer text AT2 as a second text data, the question text Q3 and the answer text AT3 as a third text data, and store these data as form of three text data into the database DB1 respectively.

In addition, the computing circuit OP2 is able to set a time period. If the passengers in the cockpit CC1 do not ask any questions within the time period, the cockpit monitoring system 100 may generate the sets of preset question texts and offer operation suggestions according to the contents of the sets of preset question texts. This disclosure is not limited to the specific length of time of the “time period”.

It should be noted that the question texts Q1-Q3, the answer texts AT1-AT3 and the operation suggestions SG1-SG2 shown in FIG. 3 are only examples for letting people having ordinary skills in this art to easily understand the technical content of this disclosure. This disclosure does not limit the specific content of the question text, the answer text or the operation suggestion, nor does it limit the need for each answer text to have a corresponding operation suggestion.

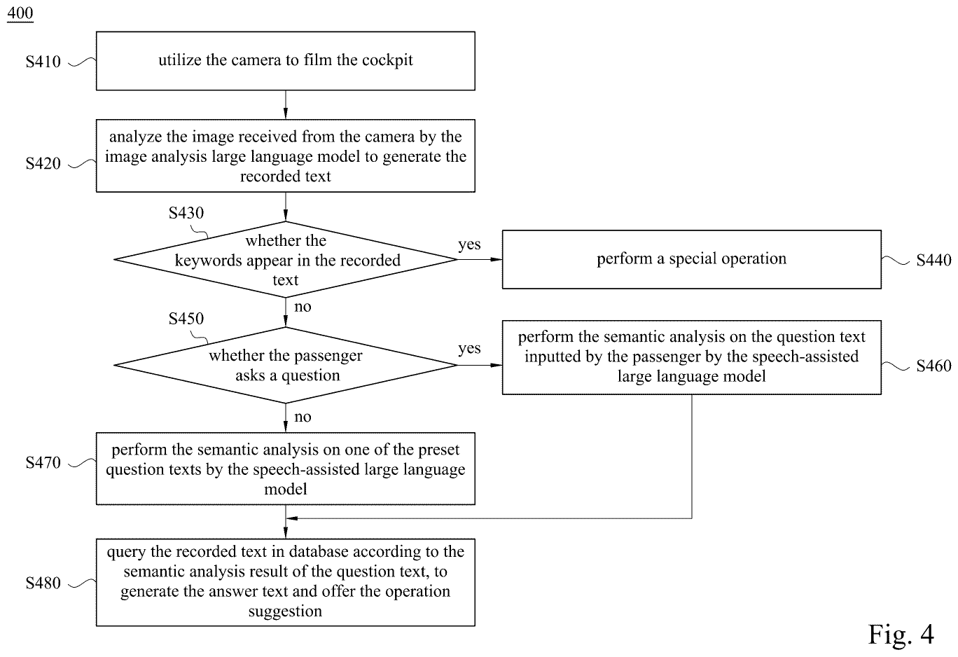

Reference is made to FIGS. 1 and 4. FIG. 4 is a flow chart of a cockpit monitoring method 400 according to an embodiment of FIG. 1. The cockpit monitoring method 400 may be configured to describe the operation of the various components of the cockpit monitoring system 100.

In step S410, the cockpit monitoring system 100 may utilize the camera CMR1 to film the cockpit CC1. The camera CMR1 may generate the image IM1 according to the image filmed by the camera CMR1, and the computing circuit OP1 of the cockpit monitoring system 100 may receive the image IM1 from the camera CMR1. The cockpit monitoring system 100 may then execute step S420.

In step S420, the computing circuit OP1 may analyze the image IM1 received from the camera CMR1 by the image analysis large language model to generate the recorded text RT1. The recorded text RT1 may be stored in database DB1. In an embodiment, the computing circuit OP2 may read out the recorded text RT1 from the database DB1; in another embodiment, the computing circuit OP2 may be coupled to the computing circuit OP1 and directly receive the recorded text RT1 from the computing circuit OP1. After receiving the recorded text RT1, the computing circuit OP2 may then execute step S430.

In step S430, the computing circuit OP2 may determine whether the keywords appear in the recorded text RT1. Specifically, at least a set of keywords or key-phrases can be set in the computing circuit OP2. One of the key-phrases may be the “specific word” mentioned above. When the computing circuit OP2 finds that recorded text RT1 contains these keywords, key-phrases or words with the similar semantics as these by the speech-assisted large language model, the computing circuit OP2 may execute step S440. When the computing circuit OP2 does not find these keywords or the key-phrases in the recorded text RT1, the computing circuit OP2 may execute step S450.

In step S440, the computing circuit OP2 may perform a special operation. Specifically, after the computing circuit OP2 finds that recorded text RT1 records the keywords, key-phrases or words with the similar semantics as these, the computing circuit OP2 may perform a system preset processing procedure according to the keywords or key-phrases. For example, one of the key-phrases in the computing circuit OP2 may be “not wearing a seat belt”. When the computing circuit OP2 finds that the recorded text RT1 contains “Passenger 3 in the front passenger seat is not wearing a seat belt”, the computing circuit OP2 may control the speaker SP1 to sound an alarm, or display in text on the vehicle display panel in the cockpit CC1: “Please fasten the seat belt, passenger in the front passenger seat, to avoid danger.” or read out the sentence by the speaker SP1.

In step S450, the computing circuit OP2 may determine whether the passenger asks a question. Specifically, the computing circuit OP2 may set a time period. If any passenger in the cockpit CC1 asks a question within the time period, the computing circuit OP2 may then execute step S460; if no passenger in the cockpit CC1 asks any question within the time period, the computing circuit OP2 may then execute step S470.

In step S460, the computing circuit OP2 may perform the semantic analysis to the question text (e.g., the question text Q1 in FIG. 3) inputted by the passenger by the speech-assisted large language model.

In step S470, the computing circuit OP2 may perform the semantic analysis to one of the preset question texts (e.g., the question text Q2 and Q3 in FIG. 3) by the speech-assisted large language model.

In step S480, the computing circuit OP2 may query the recorded text in database DB1 according to the semantic analysis result of the question text (which may be obtained from step S460 or step S470), to generate the answer text (e.g., the answer texts AT1~AT3 in FIG. 3) and offer the operation suggestion (e.g., the operation suggestions SG1-SG2 in FIG. 3). In this step, the recorded text may not only be the recorded text RT1, but also be the recorded texts accumulated when the cockpit monitoring system 100 executes the cockpit monitoring method 400 for multiple times.

In this disclosure, the cockpit monitoring system 100 may execute the cockpit monitoring method 400 multiple times. During the multiple executions of the cockpit monitoring method 400, the camera CMR1 of the cockpit monitoring system 100 may continuously film the cockpit CC1 to generate image data for use by the computing circuit OP1. The computing circuit OP1 may sequentially receive images from the camera CMR1. The amount number of the images may represent the number of times the cockpit monitoring system 100 executes the cockpit monitoring method 400. Each of the images may refer to the image IM1 in the embodiment of FIG. 1, that is, each of the images may be a continuous image of several seconds in length or a frame of a continuous image.

During the multiple executions of the cockpit monitoring method 400, the computing circuit OP1 may sequentially analyze the images by the image analysis large language model and sequentially generate recorded texts. The database DB1 can store the recorded texts in sequence. An upper limit value may be set in the database DB1. When the amount number of the texts in the database DB1 reaches the upper limit value, the database DB1 may perform a first-in-first-out (FIFO) operation to delete the earliest stored text. For example, if the upper limit value is set to 1000, when the one thousand and first image is stored, the database DB1 may delete the first image. It is worth to mention that the upper limit value is not limited to 1000 and can be adjusted according to the actual usage of the present invention.

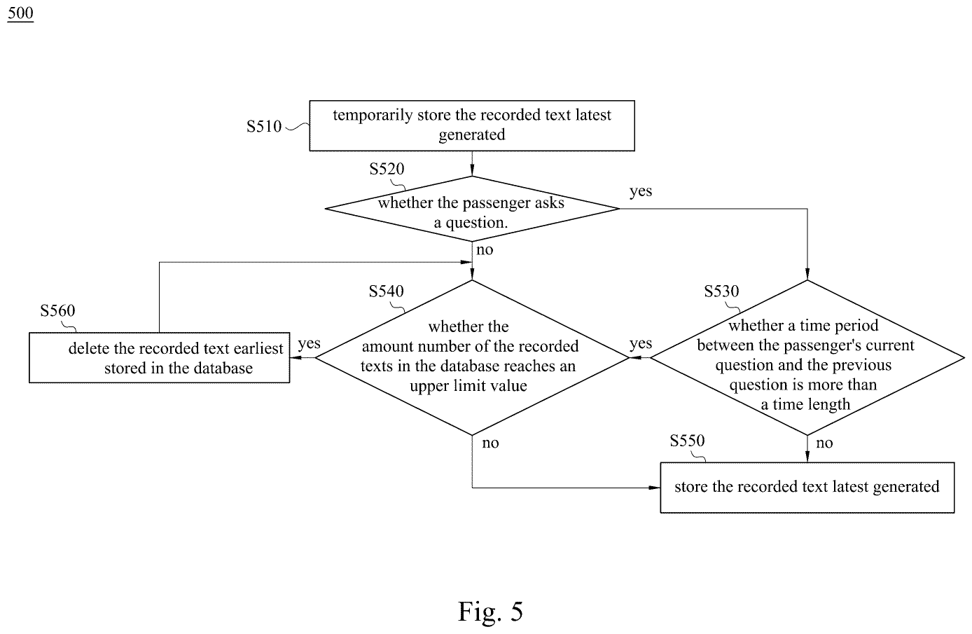

In addition to the first-in-first-out operation, the method flow of the database DB1 managing the recorded texts can also be referred to as shown in FIG. 5. FIG. 5 is a flow chart of a database management method 500 according to an embodiment of the present disclosure.

In step S510, the database DB1 may temporarily store the recorded text latest generated by the computing circuit OP1.

In step S520, the database DB1 may determine whether the passenger asks a question. Referring to FIG. 1, the database DB1 can determine whether the computing circuit OP2 stores both the question text and the answer text in the database DB1. If so, execute step S530. If not, execute step S540.

In step S530, the database DB1 may determine whether a time period between the passenger's current question and the previous question is more than a time length. This disclosure is not limited to a specific time for the above-mentioned “time period”. Specifically, the database DB1 can record time points when each set of the question texts and the answer texts is transmitted into the database DB1, so as to calculate the time period between each a time point of the passenger's question and a time point of the previous question.

If the time period between the time point of the passenger's current question and the time point of the previous question is less than the time length, it means that the passenger should be asking continuous questions. In this case, in order to allow the cockpit monitoring system 100 to completely analyze each question text continuously inputted by the passenger, the database DB1 may suspend the first-in-first-out operation and directly execute step S550.

If the time period between the time point of the passenger's current question and the time point of the previous question is more than the time length, it means that the passenger is not asking the continuous questions, or the continuously questioning has ended. In this case, the database DB1 may execute step S540.

In step S540, the database DB1 may determine whether the amount number of the recorded texts in the database reaches an upper limit value. In this embodiment, the upper limit value may be 10000. When the amount number of the recorded texts reaches the upper limit value, the database DB1 may execute step S540. When the amount number of the recorded texts does not reach the upper limit value, the database DB1 may execute step S550.

In step S550, the database DB1 may store the recorded text latest generated by the computing circuit OP1.

In step S560, the database DB1 may delete the recorded text earliest stored in the database. After completing step S560, the database DB1 may repeat step S540 to confirm whether the amount number of the recorded texts in the database is certainly less than the upper limit value.

In an embodiment, if the passenger asks too many continuous questions, letting the database DB1 to directly execute step S550 each time, it may cause the amount number of the recorded texts in database DB1 far exceed the upper limit value. For example, after the passenger's continuous questioning is completed, the amount number of the recorded texts in database DB1 is 10050, while the upper limit value is only 10000. In this case, the database DB1 must execute steps S540 and S560 multiple times until the amount number of the recorded texts in the database is deleted to be less than the upper limit value.

In summary, since the cockpit monitoring system 100 of the disclosure stores text data instead of image images, a large amount of storage space can be saved. Furthermore, the cockpit monitoring system 100 analyzes and applies text data stored in the database DB1, thereby can improve computing efficiency of the system when querying data.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the invention. In view of the foregoing, it is intended that the present invention cover modifications and variations of this invention provided they fall within the scope of the following claims.

What is claimed is:

1. A cockpit monitoring system, comprising:
a camera, configured to film a cockpit;
a first computing circuit, coupled to the camera, configured to:
analyze an image received from the camera by an image analysis large language model to generate a recorded text;
a database, coupled to the first computing circuit, configured to store the recorded text;
an input device, configured to generate a question text; and
a second computing circuit, coupled to the database and the input device, configured to:
perform a semantic analysis to the question text by a speech-assisted large language model; and
query the recorded text in the database according to a semantic analysis result of the question text to generate an answer text.

2. The cockpit monitoring system of claim 1, wherein the first computing circuit is further configured to:
utilize the image analysis large language model to identify a plurality of specific images from the image and record contents related to the specific images into the recorded text.

3. The cockpit monitoring system of claim 2, wherein the first computing circuit is further configured to:
set a plurality of passengers and a plurality of objects in the image as the specific images; and
record conditions of the passengers and the objects in the image as a form of text into the recorded text.

4. The cockpit monitoring system of claim 1, wherein the second computing circuit is further configured to:
set a preset question text;
in response to not receiving the question text, perform the semantic analysis to the preset question text by the speech-assisted large language model; and
according to a semantic analysis result of the preset question text, query the recorded text in the database to generate the answer text.

5. The cockpit monitoring system of claim 1, further comprising a speaker, wherein the second computing circuit is further configured to:
set at least one keyword;
in response to the at least one keyword appearing in the recorded text, perform a special operation; and
in response to the special operation being performed, control the speaker to emit an audio signal.

6. The cockpit monitoring system of claim 1, wherein:
the first computing circuit is further configured to:
receive a plurality of image frames sequentially from the camera; and
analyze the image frames sequentially by the image analysis large language model, and generate a plurality of texts sequentially; and
the database is further configured to:
store the texts sequentially; and
in response to an amount number of the texts reaching an upper limit value, perform a first-in-first-out operation, wherein the first-in-first-out operation comprises deleting an earliest stored one of the texts.

7. The cockpit monitoring system of claim 6, wherein the database is further configured to:
store a plurality of continuous question texts sequentially;
compare a first time point and a second time point, wherein the first time point is when one of the continuous question texts is transmitted into the database, wherein the second time point is when a previous one of the one of the continuous question texts is transmitted into the database; and
in response to a time period between the first time point and the second time point is less than a time length, suspend the first-in-first-out operation.

8. The cockpit monitoring system of claim 1, wherein the second computing circuit is further configured to:
offer an operation suggestion according to the answer text.

9. A cockpit monitoring method, comprising:
filming a cockpit by a camera;
analyzing an image received from the camera by an image analysis large language model to generate a recorded text;
storing the recorded text into a database;
generating a question text;
performing a semantic analysis to the question text by a speech-assisted large language model; and
querying the recorded text in the database according to a semantic analysis result of the question text to generate an answer text.

10. The cockpit monitoring method of claim 9, further comprising:
utilizing the image analysis large language model to identify a plurality of specific images from the image and record contents related to the specific images into the recorded text.

11. The cockpit monitoring method of claim 10, further comprising:
setting patterns of a plurality of passengers and a plurality of objects in the image as the specific images; and
recording conditions of the passengers and the objects in the image as a form of text into the recorded text.

12. The cockpit monitoring method of claim 9, further comprising:
setting a preset question text;
in response to not receiving the question text, by the speech-assisted large language model, performing the semantic analysis to the preset question text; and
according to a semantic analysis result of the preset question text, querying the recorded text in the database to generate the answer text.

13. The cockpit monitoring method of claim 9, further comprising:
setting at least one keyword;
in response to the at least one keyword appearing in the recorded text, performing a special operation; and
in response to the special operation being performed, controlling a speaker to emit an audio signal.

14. The cockpit monitoring method of claim 9, further comprising:
receiving a plurality of image frames sequentially from the camera; and
analyzing the image frames sequentially by the image analysis large language model, and generate a plurality of texts sequentially;
storing the texts sequentially; and
in response to an amount number of the texts reaching an upper limit value, performing a first-in-first-out operation, deleting an earliest stored one of the texts.

15. The cockpit monitoring method of claim 14, further comprising:
storing a plurality of continuous question texts sequentially into the database;
comparing a first time point and a second time point, wherein the first time point is when one of the continuous question texts is transmitted into the database, wherein the second time point is when a previous one of the one of the continuous question texts is transmitted into the database; and
in response to a time period between the first time point and the second time point is less than a time length, suspending the first-in-first-out operation.
